(19) United States
(12) Patent Application Publication
(10) Pub. No.: US 2004/0149822 A1
(43) Pub. Date: Aug. 5, 2004

(54) Delivery system and method using an electronic tag

(76) Inventors: John Stevens, Stratham, NH (US); Paul Waterhouse, Toronto (CA)

Correspondence Address: MCGINN & GIBB, PLLC, 8321 OLD COURTHOUSE ROAD, SUITE 200, VIENNA, VA, 22182-3817, US

(21) Appl. No.: 10/476,607

(22) PCT Filed: May 3, 2002
(86) PCT No.: PCT/US02/13903

(51) Int. Cl. G06F 17/60

(52) U.S. Cl. 235/385

(57) ABSTRACT

A delivery system includes a drop box including a first transceiver, and an electronic tag associated with a package and comprising a second transceiver. The first and second transceivers wirelessly communicate with each other in order to access the drop box.

### CROSS REFERENCE TO RELATED APPLICATIONS

This Application claims the benefit of U.S. Provisional Application No. 60/288,499 which was filed on May 4, 2001 by John Stevens and Paul Waterhouse and assigned to the present assignee, and which is incorporated herein by reference.

### BACKGROUND OF THE INVENTION

1. Field of the Invention

The present invention relates to a delivery system and method, and more particularly to a delivery system and method which uses an electronic tag.

2. Description of the Related Art

Electronic commerce has accelerated the growth of delivery companies. Purchasers can conveniently purchase goods via the Internet and have them delivered directly to their home or business. However, the home or business owner are not always present to take possession of the goods ordered. Therefore, delivery companies are seeking innovative methods of safely leaving the goods at a home or business when an owner is not available to take the delivery of the goods.

A number of such delivery systems have been devised for unattended delivery of goods using drop boxes, especially residential drop boxes. One conventional system uses a box and lock mechanism with a short-range wireless access card. The card may be programmed to open only a specific box. The box contains a memory which stores a record of openings and closings of the box. The delivery driver uses a handheld terminal which is programmed to open any box to make deliveries. Such a record can be “harvested” by the delivery driver into the hand held terminal when such a transaction is performed.

However, the handheld terminal required by this conventional system is expensive. Moreover, the drop-box is only accessible by one delivery company. Therefore, the home or business owner is required to have a drop box for every delivery company which is not practical for most consumers.

Other conventional systems utilize an expensive drop box and an expensive network connection that is either wired or wireless so that it can be actively programmed. However, these elaborate systems are not affordable to consumers.

Other less expensive conventional systems use a non-programmable keypad on the box. However, these systems does not provide secure storage of the goods.

### SUMMARY OF THE INVENTION

In view of the foregoing and other problems, disadvantages, and drawbacks of the conventional methods and structures, it is a purpose of the exemplary aspects of the present invention to provide a delivery system and method using electronic tags which can reduce (e.g., minimize) costs, ensure that the driver can open only the correct box for the package, and can prevent the driver from opening other boxes.

In a first exemplary aspect of the present invention, a delivery system includes a drop box having a first transceiver, and an electronic tag affixed to a good to be delivered and comprising a second transceiver. The first and second transceivers wirelessly communicate with each other to allow access to (e.g., to open) the drop box.

In a second exemplary aspect of the present invention, a delivery method is provided using an electronic tag, which includes inputting data to the electronic tag, and wirelessly interrogating the drop box using the electronic tag to allow access to the drop box.

The electronic tag may include, for example, a processor, a memory device and a transceiver. The drop box may include, for example, a processor, a memory device, a transceiver, and a lock mechanism.

In yet another exemplary aspect of the present invention, a programmable storage medium is provided tangibly embodying a program of machine-readable instructions executable by a digital processing apparatus to perform the inventive method of delivery using an electronic tag.

With its unique and unobvious aspects, the present invention provides a delivery system (and method) which can reduce (e.g., minimize costs), ensure that the driver can only open the correct box for the package, and prevent the driver from opening other boxes.

### BRIEF DESCRIPTION OF THE DRAWINGS

The foregoing and other purposes, aspects and advantages will be better understood from the following detailed description of exemplary embodiments of the present invention with reference to the drawings, in which:

FIG. 1 illustrates a delivery system 100 using an electronic tag 110 and drop box 120, according to an exemplary aspect of the present invention;

FIG. 2 illustrates, in greater detail, the electronic tag 110 of FIG. 1, according to an exemplary aspect of the present invention;

FIG. 3 illustrates the electronic tag 110 affixed to a package 170, according to an exemplary aspect of the present invention;

FIG. 4 illustrates, in greater detail, the drop box 120 according to an exemplary aspect of the present invention; and

FIG. 5 is a flow chart illustrating a delivery method 500 using an electronic tag, according to an exemplary aspect of the present invention;.

### DETAILED DESCRIPTION OF THE PREFERRED EMBODIMENTS OF THE INVENTION

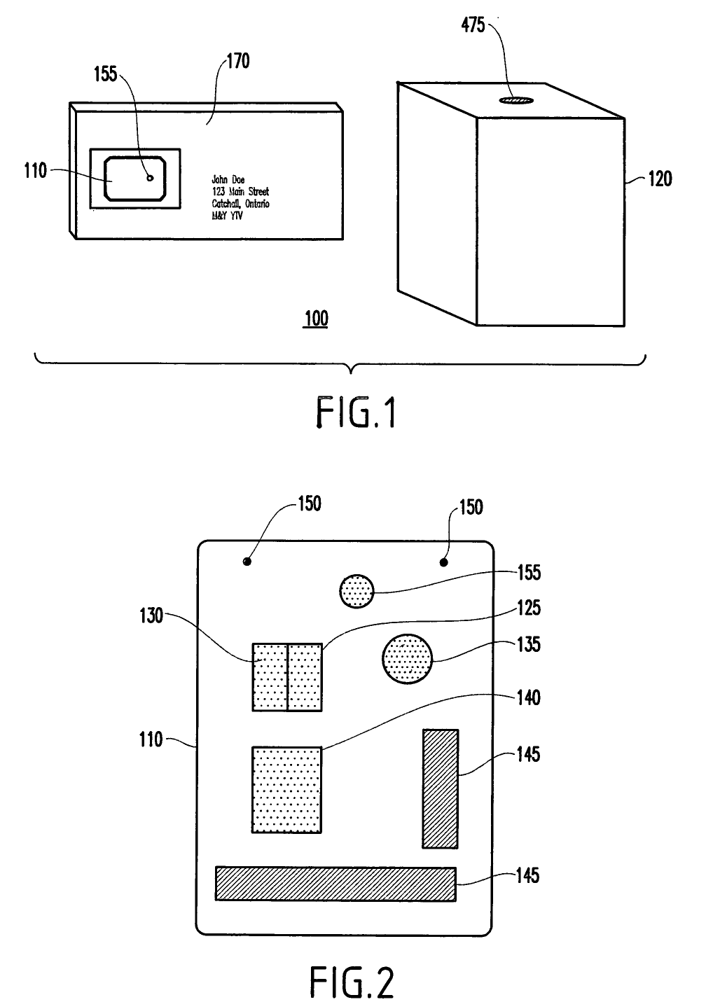

Referring now to the drawings, FIG. 1 illustrates a delivery system 100 using an electronic tag 110 and drop box 120 according to the present invention.

As shown in FIG. 1, the inventors have developed a simple, inexpensive delivery system 100 which allows for delivery (e.g., unattended delivery) from many different delivery companies. The inventive system 100 includes an electronic tag (e.g., electronic module) 110 and a drop box 120. As discussed in further detail below, the tag 110 may be affixed to a package 170 and include an activating device (e.g., button) 155 for activating any one or more of the functions of the tag 110. Further, the drop box 120 may include an activating device (e.g., button) 475 for activating any one or more of the functions of the activating device 475. In short, the tag 110 may communicate wirelessly with the drop box 120 in order to help facilitate a delivery to the address.

FIG. 2 illustrates the electronic tag 110 of FIG. 1 in greater detail. As shown in FIG. 2, the electronic tag 110 may include a processor 125 (e.g., a fixed programmed multi-bit microprocessor such as a four-bit processor), a memory device 130 (e.g., read only memory (ROM), random access memory (RAM), etc.) and a power source 135 (e.g., a battery, lithium battery, etc.). As noted above, the tag 110 may also include an activating device (e.g., button) 155 for activating any one or more of the functions of the electronic tag 110.

The tag 110 may also include a transceiver 140 (e.g., a transmitter/receiver, custom two-way communication analog chip, etc.) and an antenna 145 (e.g., two ferrite antennas) to transmit and receive data over a short range link. The power source 135 (e.g., battery) preferably has a long service life (e.g., over five years) for performing many (e.g., several thousand) transactions. Further, the electronic tag 110 optionally may include a signaling device (e.g., light-emitting device (e.g., one or two light emitting diodes (LEDs)) or an audible signaling device) 150 that can be optionally used to identify a correct package when a delivery driver arrives at the drop box 120.

The electronic tag 110 in the inventive system 100 may be similar in form and function to the electronic module described in the in-truck wireless package identification system as described in U.S. Provisional Patent Application No. 60/159,479, now PCT application No. PCT\US\00\28415, entitled “Improved Package Delivery System”, incorporated herein by reference. In addition, the electronic tag (e.g., electronic module) 110 may also be used as a warehouse-type facility or distribution center to direct a package in an operation such as that described in U.S. patent application Ser. No. 10/474,353, entitled “TOTE-BASED WAREHOUSING SYSTEM AND METHOD”, which was filed on Oct. 9, 2003, and is also incorporated herein by reference.

The electronic tag 110 may be small (e.g., about credit card size), simple, inexpensive and may be re-used many times. The tag 110 may be attached to a good (e.g., on the surface of a package containing the good) which is to be delivered. For example, the tag 110 may be included on a standard transparent shipping label which is commonly affixed to a packaging surface. Therefore, a delivery driver may view the shipping label, and note that the package has an electronic tag 110 affixed thereto, to know that the good is to be delivered to a drop box 120 located at the noted address. It should be noted that the term “good” may be construed to mean any item (e.g., documents, groceries, clothes, etc.) which may be delivered from one entity (e.g., sender) to another entity (e.g., recipient).

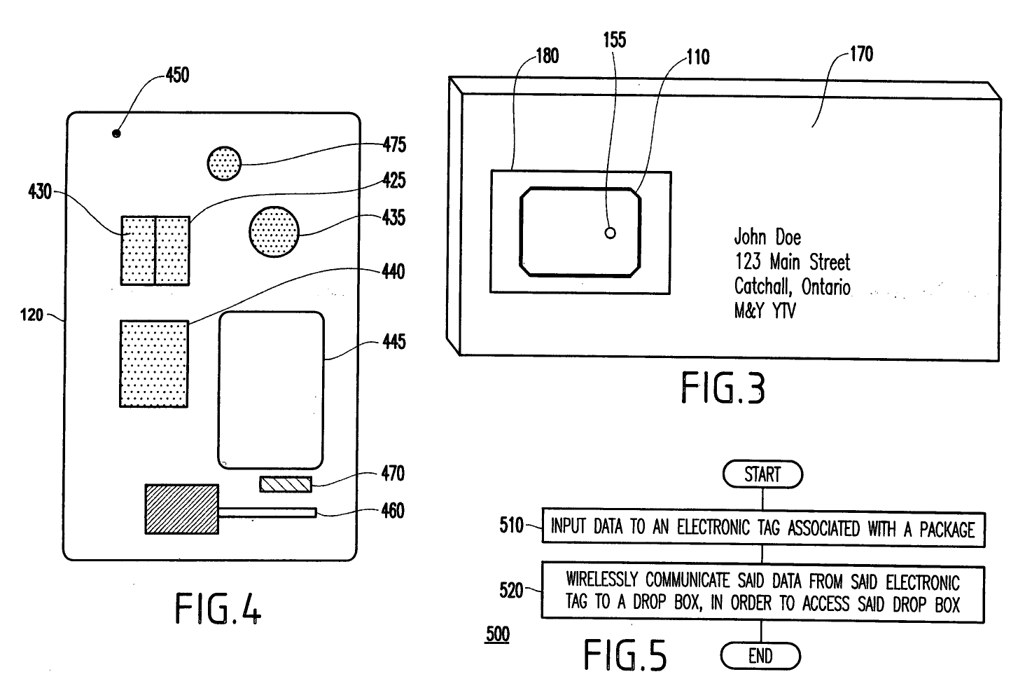

Referring again to the drawings, FIG. 3 illustrates how the electronic tag 110 might be attached to a package via a transparent plastic envelope 180 (e.g., such as an adhesive pouch) typically used for small paper invoices, bills of lading, or the like. The package may optionally have a conventional street address label as well.

The electronic tag 110 can also optionally be placed inside the package. The recipient may open the package and remove the tag 110 from the package. The recipient may then place the tag 110 in the drop box, so that it may be recovered by the delivery driver (e.g., at a later time).

FIG. 4 illustrates the drop box 120 of the inventive system 100 in greater detail. As shown in FIG. 4, the drop box 120 may include circuitry and electronics which are similar to those described above with respect to the electronic tag 110. In other words, the drop box 120 may include a processor 425 (e.g., a fixed programmed four bit microprocessor), a memory device 430 (e.g., read only memory (ROM), random access memory (RAM), etc.) and a power source 435 (e.g., a battery such as a lithium battery).

The drop box 120 may also include a transceiver 440 (e.g., a transmitter/receiver, custom two-way communication analog chip, etc.) and an antenna 445 to transmit and receive data over a communication (e.g., short range) link. As mentioned above, the power source 435 (e.g., battery) should have a long service life (e.g., over five years) over many (e.g., several thousand) transactions.

Further, the drop box 120 may also optionally include a signaling device (e.g., light-emitting device, one or two light emitting diodes (LEDs), audible signaling device, etc.) 450 that can be optionally used to identify a correct package when a delivery driver arrives. In addition, as shown in FIG. 4, the antenna 445 in the drop box 120 may include a loop antenna (e.g., a large loop antenna) for improved two-way communication.

Specifically, a unique identification (ID) number may be programmed into the drop box 120 and stored in the memory device 430. When a package is to be delivered to a certain drop box, the ID number for that certain drop box may be programmed into an electronic tag 110 on the package and stored in the memory device 130. Programming the ID number into the electronic tag 110 may be performed, for example, by using a programming device to wirelessly transmit the ID number to the electronic tag. When the package arrives at that certain drop box, a “handshake” type protocol may occur in which the ID numbers stored in the electronic tag 110 and drop box 120 may be compared and if the ID numbers match, the drop box may be automatically opened so that the package may be inserted therein.

The unique ID number for the drop box may be initially programmed into the drop box by the manufacturer. However, the drop box may be reprogrammed with a new ID number, for example, by the owner. It should be noted, however, that the drop box 120 may include a security feature that prevents the ID number of the drop box from being altered without the consent of the owner. This may be accomplished, for example, by requiring that an old identification number be input to the drop box 120 before another ID number may be programmed into the drop box 120.

The drop box 120 may further include a lock mechanism 460 for locking the door (e.g., lid) of the drop box 120 in order to control access to the inside of the drop-box. For instance, the lock mechanism 460 may include a low powered motor and a screw that can move a rod forward to lock the box 120 and rearward to unlock the box 120. Obviously, as would be known by one of ordinary skill in the art taking the present application as a whole, 110 other locking mechanisms could be employed.

The drop box 120 may also have a detector (e.g., switch) 470 to detect if the lid of the box 120 is open or closed. Further, when the lid is closed, the processor in the drop box 120 may automatically cause the lock mechanism 460 to lock the box.

In addition, the inventive system 100 may include an access card for the drop box 120. The owner may use the access card to open the drop box 120 in order to remove a package that has been delivered to the drop box 120.

The access card may include the same circuitry and electronics as described above with respect to the electronic tag 110 (e.g., as shown in FIG. 2). In other words, the access card may include may include a processor (e.g., a fixed programmed multi-bit microprocessor such as a four-bit processor), a memory device (e.g., read only memory (ROM), random access memory (RAM), etc.) and a power source (e.g., a battery, lithium battery, etc.). The access card may also include an activating device (e.g., button) for activating any one or more of the functions of the access card.

The access card may also include a transceiver (e.g., a transmitter/receiver, custom two-way communication analog chip, etc.) and an antenna (e.g., two ferrite antennas) to transmit and receive data over a short range link. The power source (e.g., battery) preferably has a long service life (e.g., over five years) for performing many (e.g., several thousand) transactions. Further, the access card may optionally include a signaling device (e.g., light-emitting device (e.g., one or two light emitting diodes (LEDs)) or an audible signaling device).

Similar to the electronic tag 110, the access card may be programmed with an identification number corresponding to the drop box 120. Furthermore, the drop box 120 and the access card may be programmable so that the identification number which unlocks the drop box 120 may be easily changed.

FIG. 5 is a flow chart illustrating a delivery method 500 according to the present invention.

As shown in FIG. 5, the inventive method 500 includes inputting (510) data (e.g., a drop box identification number) to the electronic tag 110, and wirelessly communicating (520) with the drop box using the electronic tag, in order to open the lid (e.g., door) to the drop box.

For instance, a specific drop box identification (ID) number may be programmed into the electronic tag 110 at the delivery company's warehouse. This may be performed, for example, by wirelessly communicating with the electronic tag 110 in order to program the ID number in the tag 110.

When the delivery driver arrives at the destination of the item (e.g., at the address printed on the package), the driver may push the activating device (e.g., button) 155 on the electronic tag 110 or alternatively the activating device 475 on the drop box 120. Pushing either of the activating devices 155, 475 may cause the electronic tag 110 and the drop box 120 to wirelessly communicate with each other (e.g., the electronic tag 110 may interrogate the drop box 120, and/or the drop box 120 may interrogate the electronic tag 110).

For instance, pushing activating device 155 may cause the electronic tag 110 to interrogate (e.g., transmit the programmed ID number to) the drop box 120 which may then verify that the ID number is correct. Alternatively, pushing activating device 475 may cause the drop box 120 to interrogate the electronic tag 110 in order to verify that the electronic tag 110 is programmed with the correct drop box ID number.

For example, the drop box 120 may receive the identification number transmitted from the electronic tag 110. If the drop box determines that the ID number is correct, the drop box 120 may cause the lock mechanism to open the lid of the drop box 120. In addition, the memory device in the electronic tag 110 may automatically store data, such as a time and date when that particular drop box 120 was opened.

The electronic tag 110 may be removed from the package delivered by the driver and the package placed inside the drop box 120. The drop box 120 may automatically cause the lock mechanism to lock the drop box 120 when the lid is closed. The electronic tag 110 may be retained by the delivery driver, for example, in a receipt bin of the delivery truck.

The electronic tag 110 may also be interrogated to harvest data such as the package delivery time, date and location. In addition, the electronic tag 110 may be used to automatically cause an electronic mail message including such delivery data to be transmitted, for example, to the sender (and/or the receiver) of the package. The electronic tag 110 may then be set aside for reuse.

### Second Embodiment

In a second embodiment, the electronic tag 110 is placed inside the package at the time of shipping. In this case, the delivery driver may push activating device 475 (e.g., see FIG. 4) located on the drop box 120 which would cause the drop box 120 to wirelessly communicate with the electronic tag 110. For example, the drop box 120 may interrogate the electronic tag 110 in order to verify that the electronic tag 110 is programmed with the correct drop box ID number.

Specifically, the drop box processor 425 may compare the ID number stored by the electronic tag 110 with the number stored in the drop box memory to determine if the tag 110 has been programmed with the ID number for that drop box. If the ID numbers have a predetermined relationship (e.g., if the ID numbers match), the drop box 120 may cause the lock mechanism 460 to unlock the lid of the drop box 120. The delivery driver may thereafter place the package in the drop box 120 without removing the electronic tag 110.

In this case, the delivery company may, for example, charge the box owner a refundable deposit for the electronic tag 110. To receive the deposit, the box owner may use the access card 130 to open the drop box 120, remove the electronic tag 110 from the package and return it to the drop box 110 so that the delivery company can pick up the electronic tag 110, for example, during a subsequent delivery.

In addition, if the box owner does not want the package, the electronic tag 110 may be used to return the package. In this case, the box owner would simply open the drop box using the access card 130, place the electronic tag 110 back in the drop box along with the package, and request a delivery by the delivery company. The delivery driver may then use another device (e.g., an access card, a second electronic tag, etc.) to access (e.g., access the inside of) the drop box 120 and remove the package to be returned. Therefore, the electronic tag 110 may act as a return receipt.

Alternatively, the delivery driver may be assigned an access card similar to the access card of the box owner. In this case, the delivery driver may push the activating device (e.g., button) on the access card to cause the access card to interrogate the drop box 120, or may push the activating device on the drop-box 120 to cause the drop-box to interrogate the access card. If there a predetermined relationship between the ID numbers of the drop-box and access card is determined, the drop box may cause the lock mechanism to unlock so the driver may remove the package to be returned.

Alternatively, the drop-box 120 may interrogate the electronic tag 110 contained in the package. When the drop box 120 confirms that the electronic tag 110 in the package is correct, the drop-box 120 causes the lock mechanism to unlock the lid of the drop box 120 so that driver can place the package in the drop box 120.

With its unique and novel aspects, the present invention provides a delivery system (and method) which minimizes costs, ensures that the driver can only open the correct box for the package, and prevents the driver from opening any other box.

While preferred embodiments of the present invention has been described above, it should be understood that the embodiments have been provided as examples only. Thus, those skilled in the art will recognize that the invention can be practiced with modification within the spirit and scope of the appended claims.

It is noted that the communication medium used is preferably radio frequency signals, but one of ordinary skill in the art could easily tailor the invention to use any communication medium such as optical including infrared transmissions, magnetic, sound waves, etc. so long as the tag and box may be programmable.

Further, it is noted that a programmable storage medium may be provided tangibly embodying a program of machine-readable instructions executable by a digital processing apparatus to perform the above-mentioned delivery method.

Further, Applicant's intent is to encompass the equivalents of all claim elements. No amendment to any claim in the present application should be construed as a disclaimer of any interest in or right to an equivalent of any element or feature of the amended claim.

What we claim is:

1. A delivery system, comprising:
a drop box comprising a first transceiver; and
an electronic tag associated with a package and comprising a second transceiver,
wherein said first and second transceivers wirelessly communicate with each other in order to access said drop box.

2. The delivery system according to claim 1, wherein said drop box further comprises a first memory device for storing a first identification number, and wherein said electronic tag further comprises a second memory device for storing a second identification number.

3. The delivery system according to claim 2, wherein said drop box further comprises a processor for comparing said first identification number and said second identification number.

4. The delivery system according to claim 1, wherein said first and second transceivers each comprise a two-way communication analog chip.

5. The delivery system according to claim 2, wherein said electronic tag further comprises a processor for comparing said first identification number and said second identification number, and wherein said drop box unlocks when said first identification number has a predetermined relationship with said second identification number.

6. The delivery system according to claim 1, wherein said electronic tag further comprises an activating device to activate a function of said electronic tag.

7. The delivery system according to claim 6, wherein said activating device is engaged in order to transmit data from said electronic tag to said drop box.

8. The delivery system according to claim 1, wherein said drop box further comprises an activating device to activate a function of said drop box.

9. The delivery system according to claim 8, wherein said activating device is engaged in order to transmit data from said drop box to said electronic tag.

10. The delivery system according to claim 2, wherein at least one of said first and second memory devices store delivery data comprising a delivery date and delivery time.

11. The delivery system according to claim 1, wherein said electronic tag is affixed to an outside portion of said package.

12. The delivery system according to claim 1, wherein said electronic tag is contained inside said package.

13. The delivery system according to claim 1, further comprising:
an access card comprising a third memory device and a third transceiver,
wherein said second and third transceivers wirelessly communicate with each other in order to access said drop box.

14. An electronic tag associated with a package, comprising:
a processor;
a memory device coupled to said processor for storing delivery information; and
a transceiver for wirelessly communicating data from said memory device to a drop box in order to access said drop box.

15. A drop box for a delivery system, comprising:
a processor;
a memory device coupled to said processor for storing delivery information;
a transceiver for wirelessly communicating data from said memory device to an electronic tag in order to access said drop box; and
a lock mechanism operatively coupled to said processor.

16. A delivery method, comprising:
inputting data to an electronic tag associated with a package; and
wirelessly communicating said data from said electronic tag to said drop box, in order to access said drop box.

17. A programmable storage medium tangibly embodying a program of machine-readable instructions executable by a digital processing apparatus to perform a delivery method, said method comprising:
inputting data to an electronic tag associated with a package; and
wirelessly communicating said data from said electronic tag to said drop box, in order to access said drop box.

18. The delivery system according to claim 3, further comprising:
a lock mechanism operatively coupled to said processor.

19. The delivery system according to claim 18, wherein said drop box unlocks said lock mechanism when said first identification number has a predetermined relationship with said second identification number.

20. The delivery system according to claim 1, wherein said drop box further comprises a signaling device, said first and second transceivers wirelessly communicating with each other to activate said signaling device and identify said drop-box as a destination of said package.
